(19) United States
(12) Patent Application Publication
(10) Pub. No.: US 2019/0293846 A1
(43) Pub. Date: Sep. 26, 2019

(54) DISPLAY SCREEN CONFIGURED TO DISPLAY VIEWING POSITION-DEPENDENT IMAGES

(71) Applicant: MirraViz, Inc., Fremont, CA (US)

(72) Inventors: Michael Wang, Sunnyvale, CA (US); Matthew Resman, Sunnyvale, CA (US)

(21) Appl. No.: 16/439,489

(22) Filed: Jun. 12, 2019

Related U.S. Application Data
(63) Continuation of application No. PCT/US2017/065910, filed on Dec. 12, 2017.
(60) Provisional application No. 62/433,396, filed on Dec. 13, 2016.

(51) Int. Cl. G02B 5/124; G02B 5/02

(52) U.S. Cl. CPC G02B 5/124; G02B 5/02

(57) ABSTRACT

The disclosed technology generally relates to displays, and more particularly to display screens configured to display viewing position-dependent images. A display screen configured to display viewing position-dependent images comprises a retro-reflective display medium configured to display a primary image by reflecting incident light from a first light source towards a first viewing position. The display screen additionally includes a secondary display medium configured to display a secondary image. The retro-reflective display medium and the secondary display medium are stacked in a display depth direction and overlap in a lateral direction perpendicular to the display depth direction

### CROSS-REFERENCE TO RELATED APPLICATIONS

This application is a continuation of PCT Application No. PCT/US2017/065910, filed on Dec. 12, 2017, which claims the benefit of priority of U.S. Provisional Application No. U.S. 62/433,396, filed Dec. 13, 2016. Each of the above applications is incorporated herein by reference in its entirety. All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BACKGROUND

### Field

The disclosed technology generally relates to displays, and more particularly to display screens configured to display viewing position-dependent images.

### Description of the Related Technology

Current state-of-the-art display systems generally consist of either flat-panel displays or projector-based displays. The flat-panel displays are generally based on liquid crystal display (LCD) pixels with light emitting diode (LED) backlighting, plasma-based screens, organic light emitting device (OLED) based, or discrete LED based systems. In these display systems, it is difficult to attain screen sizes significantly larger than 80 inches at low cost in width due to several considerations. For flat-panel displays, nonlinear increases in cost as the screen size grows, as well as high power consumption, may limit screen sizes to below 80 inches at typical consumer price points. For projection-based displays, many factors limit increases in screen size, including: decreased brightness, increased power consumption, large projector size and projector noise. Additionally, for these types of display systems it is generally not technically feasible, or is prohibitively expensive to implement multi-viewer capabilities into the system wherein multiple viewers may each view completely different content over the entire area of the screen at same time.

An alternative display system has been proposed to use a retro-reflective (RR) display surface to allow for increase display size with high brightness levels and multi-viewer capability. Current state-of-the-art retro-reflective material is opaque sheeting that reflects light back to its source. The typical usage for this system is traffic safety and security. Retro-reflective sheeting used for traffic purposes include signs, asphalt reflectors, wearables and automobiles. Typical source of light is from automobile and motorcycle headlights. Retro-reflective sheeting used for security purposes include: warnings, directions. Typical light sources include airplanes, boats, and cars.

Furthermore, current state-of-the-art retro-reflective systems do not engineer the retro-reflective material to be optimized for RR display systems.

### SUMMARY OF CERTAIN INVENTIVE ASPECTS

In a first aspect, a display screen configured to display viewing position-dependent images comprises a retro-reflective display medium configured to display a primary image by reflecting incident light from a first light source towards a first viewing position. The display screen additionally includes a secondary display medium configured to display a secondary image. The retro-reflective display medium and the secondary display medium are stacked in a display depth direction and overlap in a lateral direction perpendicular to the display depth direction.

In another aspect, a display system comprises the display screen of the first aspect configured to display viewing position-dependent images. The display system additionally comprises the first light source comprising a projector configured to direct the incident light towards the retro-reflective display medium to display the primary image. The display system further includes a micro-processor in communication with the projector, wherein the micro-processor is programmed to control the first light source to direct the incident light towards the retro-reflective display medium.

In another aspect, a method of displaying viewing position-dependent images comprises displaying a primary image from a retro-reflective display medium by reflecting incident light from a first light source towards a first viewing position. The method additionally includes displaying a secondary image from a secondary display medium. The retro-reflective display medium and the secondary medium are stacked in a display depth direction and are laterally overlapping in a lateral direction perpendicular to the depth direction, such that displaying the primary image and the secondary image comprises displaying through a common viewing surface of the display.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings, equations and description are to be regarded as illustrative in nature, and not as restrictive.

### BRIEF DESCRIPTION OF THE DRAWINGS

The novel features of the invention are set forth with particularity. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 schematically shows a magnified front view of a retro-reflective display medium, according to embodiments;

FIG. 2 schematically illustrates a retro-reflective display medium with retro-reflective screen elements having intersecting planes, according to embodiments;

FIG. 3 schematically shows a top view of a display system including a retro-reflective display medium and projector with the viewer facing the screen, according to embodiments;

FIG. 4 schematically shows a display screen for displaying viewing position-dependent images that is configured as a hybrid retro reflective and mirror display, according to embodiments;

FIG. 5 schematically shows a display screen for displaying viewing position-dependent images that is configured as a hybrid retro-reflective and mirror display having an increased brightness and intensity of the RR portion of the display screen;

FIG. 6 schematically illustrates the multiuser capability of the hybrid RR mirror display system illustrated in FIG. 5;

FIG. 7 schematically shows a display screen for displaying viewing position-dependent images including hybrid RR overlay display screen, comprising a semi-transparent or transparent RR layer combined with active or static portion of the display system behind the RR layer, according to embodiments;

FIG. 8 schematically illustrates the multiuser capability of the hybrid RR overlay display system illustrated in FIG. 7;

FIG. 9 schematically shows a display screen for displaying viewing position-dependent images configured as a hybrid RR static-overlay display that is optimized for system performance using a perforation approach on the static overlay portion of the system, according to embodiments;

FIG. 10 schematically shows a display screen for displaying viewing position-dependent images including a hybrid RR overlay display that is optimized for the system performance using a perforation approach on the RR portion of the system, according to embodiments;

FIG. 11 schematically shows a display screen for displaying viewing position-dependent images including a hybrid RR overlay display that is optimized for system performance using a perforation approach on a layer of the system between the RR layer and the static or active content behind the RR layer, according to embodiments;

FIG. 12 schematically shows the impact of the perforation layer in combination with a layer that substitutes for air on the backside of the RR layer, according to embodiments;

FIG. 13 schematically shows a display screen for displaying viewing position-dependent images, the display screen having a sequence of layers for a hybrid RR-mirror-active display system, according to embodiments;

FIG. 14 schematically shows a display screen for displaying viewing position-dependent images including an hybrid RR direct print display in which a digitally “perforated” pattern is printed directly on the RR layer, according to embodiments;

FIG. 15 schematically shows a display screen for displaying viewing position-dependent images including a hybrid RR-active combined display system that implements a curvature in order to optimize the RR display properties;

FIG. 16 schematically shows a display screen for displaying viewing position-dependent images including a hybrid RR-active combined display that combines RR and active display elements;

FIG. 17 schematically illustrates a display system to enable a semi-transparent double sided display media;

FIG. 18 schematically illustrates a computer system programmed or otherwise configured to facilitate methods of the present disclosure;

FIG. 19 schematically illustrates a method of displaying viewing position-dependent images, according to embodiments.

### DETAILED DESCRIPTION OF CERTAIN ILLUSTRATIVE EMBODIMENTS

The present disclosure provides display systems and methods that address various limitations of other display systems and currently available. A display system of the present disclosure can include a projector and a combination of various layers including retro-reflective (RR) layers to result in a hybrid RR display system which can provide various non-limiting benefits over other systems currently available. For example, systems of the present disclosure may provide a unique display such that multiple users are viewing the same screen with each viewer seeing their own content from the RR portion of the system while at the same time other viewers are seeing static or active media content from the non-RR portion of the system. As another example, a display system of the present disclosure can permit multiple viewers to view individual customized image or video streams on the same screen, while other viewers see a static poster or traditional digital television behind the screen surface. The present disclosure provides methods to optimize such RR-based display systems.

The present disclosure provides display systems utilizing a projector and a retro-reflective screen. Such display systems comprise a projector combined with a retro-reflective screen and a viewer distance from the projector such that an observation angle and/or a return angle is substantially small, in some cases less than approximately 20 degrees, 10 degrees, 5 degrees, 3 degrees, 2 degrees, or 1 degree.

The present disclosure provides systems and methods to engineer and optimize the physical and optical properties of hybrid RR-based display system such that the display properties meet the requirements for each specific use case.

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “retroreflective” (also “RR”, “retro-reflective” or “retro-reflective” herein), as used herein, generally refers to a device or surface that reflects light back to its source with a minimum scattering of light. In a retro-reflective screen, an electromagnetic wave is reflected back along a vector that is parallel to but opposite in direction from the source of the wave. A retroreflective screen comprises a retro-reflective surface comprised of many small individual retro-reflective (RR) elements. The RR elements may be based on bead type optical element which may be spherical in nature, or the RR element maybe based on corner cube reflective elements.

The term “corner cube reflective element”, as used herein, generally refers to a reflective partial cube composed of three mutually perpendicular, nearly perpendicular, or angled flat reflective surfaces. With this geometry, incident light is reflected back directly towards the source. The configuration of a corner cube reflective element may comprise elements containing only triangular shaped surfaces or may comprise elements containing portions of triangular shaped surfaces, or may comprise surface that are polygon in nature in order to maximize the percentage of photons that undergo 3 reflections. The latter type of element is sometimes described as “full-cube” structures. In some cases the angles between the surface normal vectors for the 3 surfaces comprising each corner cube element are exactly 90 degrees. In other cases, the angles between the 3 surface normal vectors deviate from exactly 90 degrees in order to optimize the retro-reflected light profile as described in U.S. Provisional Patent Application No. 61/997,206.

The term “projector,” as used herein, generally refers to a system or device that is configured to project (or direct) light. The projected light can project an image and/or video.

The term “observation angle,” as used herein, generally refers to an angle between a first line directed from a light source, e.g., a projector for retro-reflective display media, to a given location on a screen and a second line from that same location on the screen to one or more eyes of a viewer.

For retro-reflective display media, a range of observation angles can be described as a range of angles centered around the second line, outside of which the luminance or intensity of the image reflected from the screen falls off by, e.g., more than 30%, 50%, 70% or 90%, whose value can be relatively small, e.g., less than about 20 degrees, less than about 10 degrees, less than about 5 degrees, less than about 3 degrees, less than about 2 degrees, or less than about 1 degree.

For reflective display media that are not retro-reflective, such as, e.g., secondary media comprising a mirror or a static content layer as descried infra, the light source may be external light, and the range of observation angles are relatively large, e.g., greater than about 60 degrees, greater than about 90 degrees, greater than about 120 degrees, greater than about 150 degrees or greater than about 170 degrees.

For non-reflective display media such as, e.g., secondary media comprising an active content layer, since the image is formed is not a reflective image, a range of observation angles can be described as a range of angles centered around a line normal to the display media, outside of which the contrast ratio falls off by, e.g., more than 30%, 50%, 70% or 90%, whose value can be e.g., greater than about 60 degrees, greater than about 90 degrees, greater than about 120 degrees, greater than about 150 degrees or greater than about 170 degrees, depending on the type of active content layer. For example, light emitting diode (LED) displays and organic light emitting diode (OLED) displays may have higher ranges of observation angles, while liquid crystal displays (LCDs) may have lower ranges of observation angles.

The term “return angle,” as used herein, generally refers to the angle between an incident beam of light and the reflected beam of light from a screen. For a typical surface, the return angle has a broad range of values. For a retro-reflective screen that has not been formed as described herein, the return angle typically has a very small spread of angles centered around zero.

The term “incidence angle,” or sometimes referred to as “entrance angle” as used herein, generally refers to an angle between a first line directed from a projector to a given location on a screen and a second line that is normal to the nominal front surface of the corner cube. The nominal front surface of the corner cube is defined as the surface perpendicular to and intersecting the mid-point of a line from the corner of the corner cube structure to the hypothetical opposite corner of the cube if the corner cube were to have been a full cube.

The term “optical cross-talk” (also “cross-talk” herein), as used herein, generally refers to retro-reflected light from a projector that reaches a viewer (or eye of a viewer) that was not intended to receive the light. This can result in a poor 3D viewing experience exhibited by “ghosting” which is a term used herein to describe double images seen by viewers where only one image is intended. The term “perceived cross-talk” as used herein, generally refers to the ratio of the intensity of undesired retro-reflected light from a projector that reaches a viewer (or eye of a viewer) relative to the intensity of desired retro-reflected light. There may be scenarios where absolute cross-talk intensity has decreased, but the intensity of desired light has decreased by an even larger amount, resulting in worsening in perceived cross-talk.

The present disclosure provides a display system that permits multiple viewers to simultaneously view individual customized content such as but not limited to video, photos, games, advertisements or productivity software simultaneously on the same screen. Additionally, the present disclosure provides a method to enable other viewers to observe objects or content in front of or behind or interleaved with the RR portion of the display system. The display system can comprise a projector combined with various optically opaque, transparent, perforated or semi-transparent layers combined with a RR layer.

### Retro-Reflector Display Systems

In an aspect, a display system comprises a retro-reflective screen having retro-reflective screen elements that reflect light along a direction that is substantially non-parallel to the direction of propagation of the light. Each of the retro-reflective screen elements comprises at least three intersecting planes (e.g., in the form of a pyramidal structure or truncated pyramidal or non-triangular faced structures sometimes referred to as full-cube structures). At least one of the three intersecting planes can intersect an adjacent plane (e.g., of the same retro-reflective screen element) at an angle that is 90° with an offset greater than 0°. The system further comprises at least one projector that projects the light onto the retro-reflective layer, which light characterizes an image or video. The retro-reflective screen can include truncated or full corner cube reflectors. In some cases, the system comprises multiple projectors. For example, the system can include two projectors that provide a stereoscopic image or video for 3D viewing. For example, the image or video is rendered by more than one projector such that, upon reflection by the retro-reflective screen, the image or video is three-dimensional.

The projector can be mountable on a body of a viewer. In some examples, the projector is mountable on a head of the viewer. The projector can be mountable with a support member, such as body or head support member (e.g., support strap(s)). The projector can also be mounted at a fixed location, independent of the viewer such that a viewer may enter the range of the projector. The projector can also be mounted on a movable mount such that the project can move with or follow an intended viewer. The projector system can also be comprised of multiple projectors in relatively close proximity in order to increase the viewing area for a given viewing location.

The display system can include a sound system for providing sound to complement the image or video. The sound can go along with a viewer's viewing experience, such as by way of headphones or other local speaker system. The sound system may be a directed sound system such that the sound has high intensity at a desired location in comparison to other locations.

The display system can include a system for tracking the location of the users as well as the direction the users are facing as well as the direction that the users are looking. This tracking systems can be done using a variety of techniques, including, but not limited to: accelerometers, gyroscopes, electro-magnetic signal detection, visible light or infra-red lighting and cameras, or body mounted markers combined with cameras.

The retro-reflective screen can have various sizes and configurations. The screen can be substantially flat or curved. The curvature of the screen can be either convex or concave with respect to the viewer. The screen can have a width of at least about 1 meter (m), 10 m, or 50 m, and a height of at least about 0.5 m, 10 m or 50 m. The screen can also have a shape that is not rectangular. In large area settings, a large area display can be effective for advertising purposes, or other showcase demonstrations, due, at least in part, to the qualities of the display size and having multiple images/videos on the same screen area. The retro-reflective screen can also be non-stationary.

Reference will now be made to the figures. It will be appreciated that the figures and features therein are not necessarily drawn to scale.

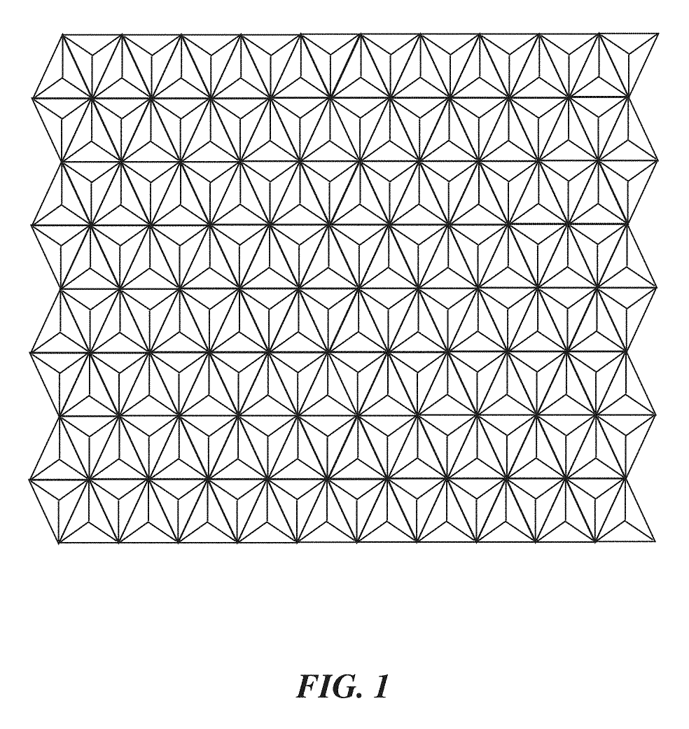

FIG. 1 shows a front view of a representative retro-reflective screen. The retro-reflective screen is comprised of an array of truncated corner cube reflectors. The corner cube reflectors may also be comprised of alternative geometries. Examples of corner cube reflectors are provided in U.S. Pat. No. 5,763,049 to Frey et al. and U.S. Pat. No. 7,261,424 to Smith, which patents are entirely incorporated herein by reference. In some embodiments, the size of each of the corner cube reflectors is smaller than the anticipated or predicted pixel size of the projected image, with the pixel size determined by the combination of the projector display system and the distance of the projector from the retro-reflective screen.

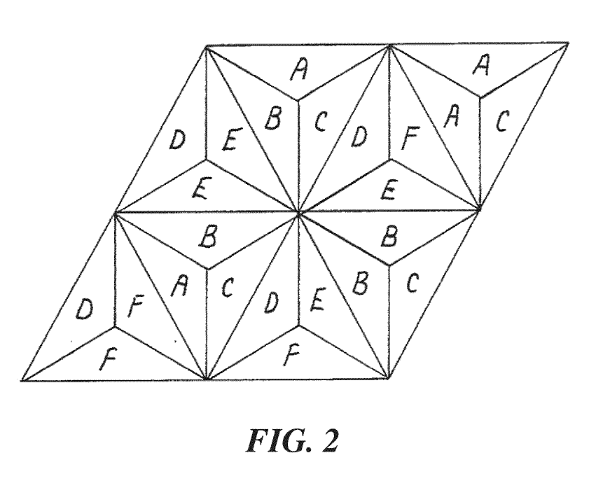

A retro-reflective screen can include retro-reflective screen elements having intersecting planes. This is schematically illustrated in FIG. 2, which shows pyramidal retro-reflective screen elements with intersecting planes A-F. Planes of adjacent elements may intersect one another at an angle that is 90°. For example, Planes B and C at the bottom left-hand portion of the schematic intersect at an angle of 90°. In some cases, at least one of three intersecting planes can intersect an adjacent plane (e.g., of the same retro-reflective screen element) at an angle that is 90° with an offset greater than 0°. For example, the D plane at the bottom left-hand portion of FIG. 2 can intersect the E plane at an angle that is 90° with an offset greater than 0°.

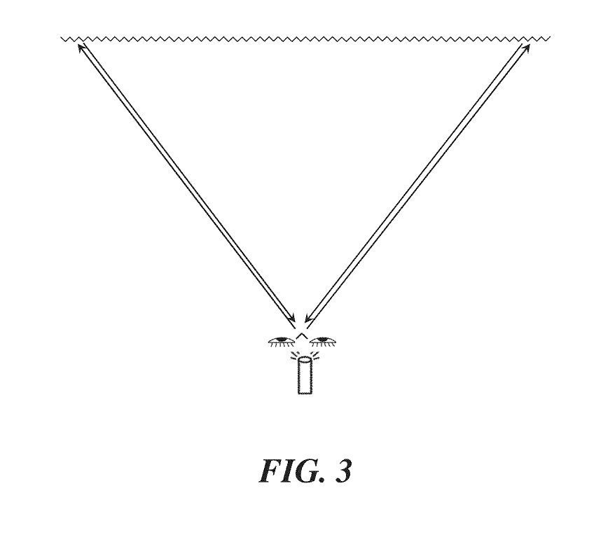

FIG. 3 shows a schematic top view of a system having a projector and a retro-reflective screen. The retro-reflective properties of the screen cause a majority of the light incident upon the screen to be reflected back towards the projector in a tight directional cone of light regardless of the incident angle. This is in contrast to some conventional screens which scatter incident light in a relatively isotropic manner. In such a conventional screen set up only a very small fraction of the light incident on the screen actually impinges upon the viewer's eyes. Because of the retro-reflective effect with this type of system, if the viewer's eye(s) is in close proximity to the projector such that the angle defined by the path from the projector to the reflective screen and returning to the viewer's eye is small, then the brightness of the image may be increased significantly over a conventional projector and reflective screen set up. The system of FIG. 3 in some cases does not have a beam splitter. In cases incorporating methods described in U.S. Patent Publication 61/997,206 the viewer and/or the viewer's eye(s) may be at an observation angle that is significantly larger than in scenarios not incorporating.

In the following, various embodiments of a display screen configured to display viewing position-dependent images are described. In various embodiments, the display screen comprises a retro-reflective display medium configured to display a primary image by reflecting incident light from a first light source towards a first viewing position. The display screen additionally includes a secondary display medium configured to display a secondary image. The retro-reflective display medium and the secondary medium are stacked in a display depth direction and are laterally overlapping in a lateral direction perpendicular to the depth direction.

In various embodiments, the retro-reflective medium includes a retro-reflective layer or screen as described above with respect to FIGS. 1 and 2. In the following, a primary image refers to an image which is formed, e.g., primarily formed, by the retro-reflective medium in the presence of light from a projector. A secondary image refers to an image which is formed, e.g., primarily formed, by the secondary display medium and not by retro-reflection. It will be appreciated that the presence of the secondary image can be independent of the light source causing the primary image, and the presence of the primary image can be independent of the light source causing the secondary.

In various embodiments described herein, a display screen is configured such that the primary image is visible from the first viewing position within first range of observation angles, wherein the secondary display medium is configured such that the secondary image is visible from a second viewing position within a second range of observation angles substantially greater than the first range of return angles and including the first range of return angles. In embodiments, the first range of observation angles is centered about a direction of reflection of the incident light towards the first viewing position can be less than about 20 degrees, or less than about 8 degrees, e.g., using apparatuses and methods described in U.S. Provisional patent application Ser. No. ______, or less than about 5 degrees, less than about 2 degrees or less than about 0.5 degrees, e.g., using other apparatuses and methods. In some embodiments, the luminance of the primary image falls off by more than about 50% outside the first range of observation angles. In embodiments, the luminance of the secondary image is less than about 10% relative to a luminance of the primary image within the first range of observation angles when the primary image is present. In embodiments, a luminance of the secondary image less than about 25% of a luminance of the primary image within the first range of observation angles when the primary image is present. In embodiments, one or both of the retro-reflective display medium and the secondary display medium comprise a partially transparent layer having local regions that are modified to have increased transparency relative to remaining regions. In various embodiments, it will be appreciated that the luminance or the intensity of the primary image falls off in a continuous manner as an observer moves away, e.g., laterally away, from the direction of reflection. For example, in some embodiments, where the fall-off profile of the luminance or intensity of the primary image can be described using a Gaussian curve, the peak of the Gaussian curve corresponds to the direction of reflection, while the fall-off the Gaussian curve corresponds to the fall-off of the luminance or intensity of the primary image.

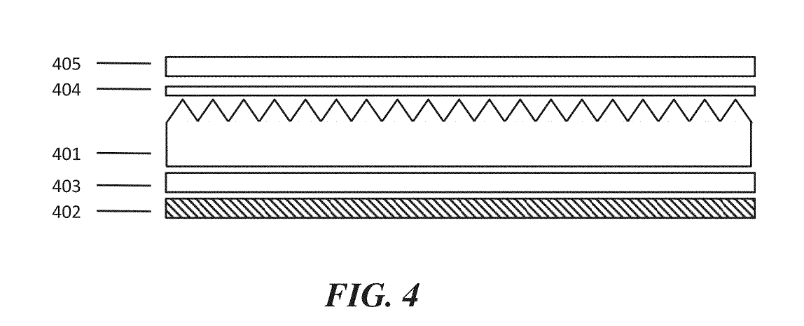

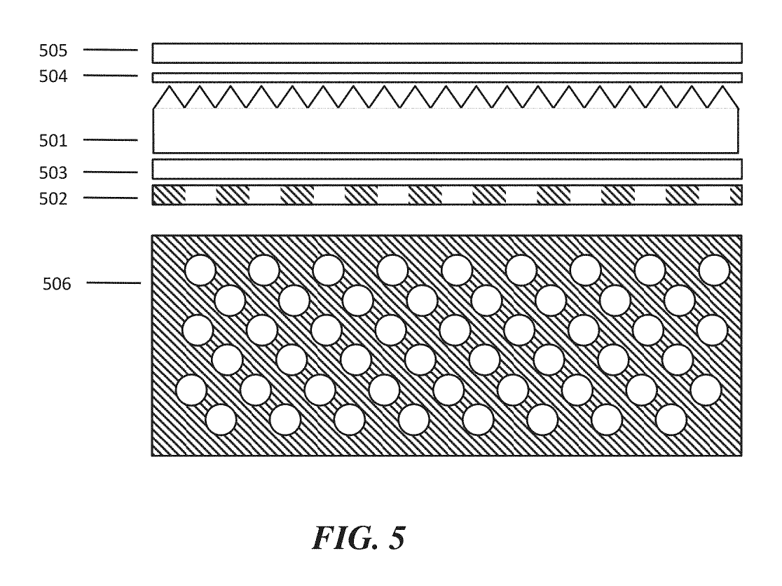

FIGS. 4 and 5 display screens configured to display viewing position-dependent images, according to embodiments, wherein the retro-reflective display medium is formed at a greater depth than the secondary display medium relative to a display surface, and wherein the secondary display medium is configured to partially transmit light directed to the retro-reflective display medium. In particular, the secondary display medium is configured to serve as a mirror which partially reflects external light such that the secondary image comprises a mirror image.

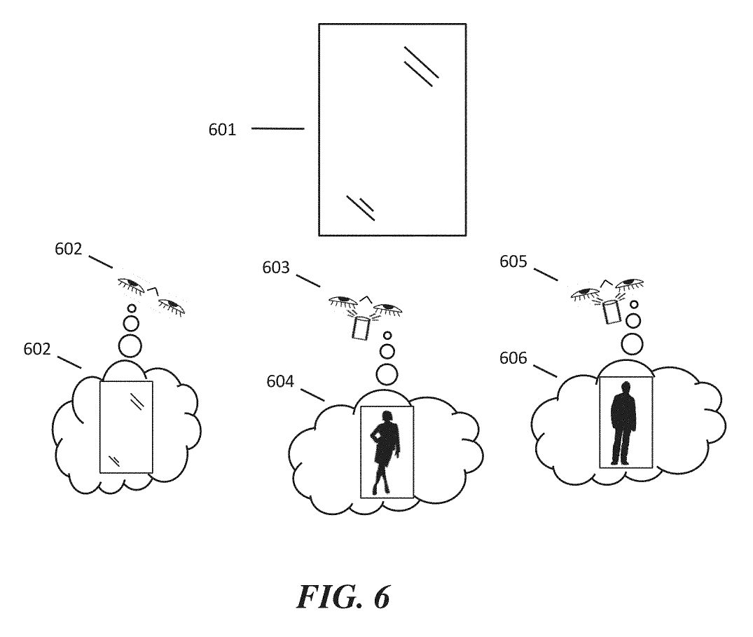

FIG. 4 schematically shows a basic hybrid retro reflective and mirror display system using multiple layers to achieve a system that performs like a mirror when viewed from most locations and performs as a RR display system when viewed from other specific locations. A representative sequence of layers is described as follows. A retro-reflective display medium includes a RR film 401 with retro-reflective optical elements. For illustrative purposes, 401 and other RR representative drawings herein are drawn schematically with a corner cube configuration, however 401 may also be comprised of bead based retro-reflective elements. A secondary display medium includes a partially or semi-reflective layer 402 that reflects a portion of incident light and allows a portion of the incident light to transmit through 402. The relative percentage of light reflected versus transmitted may range from <10% reflected and >90% transmitted to >90% reflected and <10% transmitted depending upon the specific application needs. 403 is an optional transparent layer that may be used for improved flatness or system level structural rigidity. Additional transparent optical adhesive layers may also be incorporated between various layers for mounting purposes. In this and subsequent figure descriptions, theses optically transparent adhesive layers may be described or maybe assumed to already be incorporated as a part of other described layers/films. 404 represents an optional backing layer. In some cases, if a semi-transparent RR layer 401 is utilized, there may be a benefit to include a dark backing layer 404 to improve the mirror properties of layer 402. In other cases, it may be desirable to have white other colors for the backing layer. 405 is an additional optional rigid or flexible backing layer. A rigid overall structure may be desirable for some applications. For other applications, there may be a significant benefit to have all layers be flexible in order to be able roll up a large display for a more portable system or for a system than can more readily be paired with other more traditional display systems. The described sequence of layers results in a unique hybrid mirror and RR display system in the following manner. From most viewing locations, light reaching the front surface of semi-reflective layer 402 is originating from many directions and will partially reflect in a manner very similar to light reflecting off of a traditional mirror. The viewers in these locations will see a mirror. The portion of light that is not reflected from the front surface of 402 will be incident upon the RR layer 401. This light will retro-reflect back to the source which will result in a bright image to viewers near that source. These viewers will see a displayed image with a higher intensity than the mirror-like appearance of 402. An illustrative figure and description follows in FIG. 6. It should be noted that in this Figure as well as in subsequent Figures that the different layers are drawn with small spaces between each layer for visual clarity. In actual practice, the layers may be in direct contact or may in some cases have a space between layers depending on the specific application.

FIG. 5 schematically shows a hybrid retro-reflective and mirror display system with an illustrative method to increase the brightness and intensity of the RR portion of the display system. In some cases the system and method described in FIG. 4 may result in too much loss of RR display intensity. For example, if a highly reflective mirror surface is used for 402 resulting in 80% light reflection, then only roughly 20% of light reaches layer 401 and of that 20%, only another 20% of the retro-reflected light passes back through layer 402. This results in only approximately 4% (0.2×0.2=0.04) of incident projected intensity of light to be available for the RR display system. An alternative method to achieve both high quality mirror properties and high quality RR display system intensity is shown in FIG. 5. In this figure, layers 501 through 505 are shown from a side view. 506 shows the front view of layer 502. The detailed description of each layer follows. A retro-reflective display medium includes a RR layer 501. A secondary display medium a perforated partially reflective mirror film 502. The primary characteristic of this film is that a portion of the film allows passage of light through the film with minimal or no absorption or reflection. 503 is an optional transparent layer analogous to 403. 504 represents an optional backing layer analogous to 404. 505 is an additional optional rigid or flexible backing layer analogous to 405. 506 shows a front view of 502. In this illustrative drawing, round holes are drawn to represent the areas of the film which are “perforated” to allow light to pass through the layer 502/506 without either absorption or reflection in the region of the holes. In comparison to the above example of a desired 80% reflectance, if a film with 100% reflectance is used in combination with perforations over 20% of the surfaces, then the 80% reflectance is achieved. However, 20% of the incident light is now able to pass through layer 502/506. After retro-reflection at layer 501, that incident light returns along the same path through the same perforated hole and does not get absorbed or reflected. In this illustrative example 20% of incident light contributes to the RR display intensity which is a ˜5× increase over the 4% example described in FIG. 4. The illustrative drawing for 506 shows holes with a certain pitch and size, however this is illustrative only, and many different shapes, pitches and sizes may be used to achieve the same benefit. In general, for best practices, it is often desirable to have the pitch and holes size be small enough such that the perforations are not too noticeable to the viewers. Also, the hole size should not be significantly smaller than the size of the typical RR element used in layer 501, otherwise small deviations in the retro-reflected light return path may result in undesired absorption or reflection of a portion of the retro-reflected light.

As configured, in the embodiments described above with respect to FIGS. 4 and 5, when the projector is turned off, the entire display screen may serve as mirror.

FIG. 6 schematically illustrates the multiuser capability of the hybrid RR mirror display system. The display screen 601 is a front view of the hybrid mirror/RR display system. 602 represents the class of viewers that may be observing a secondary image, and not using the system as a RR display. With no projector source in proximity to the viewer 602, that viewer sees what appears to be a traditional mirror. Only one viewer is shown in the Figure, but many viewers will be able to observe the hybrid display as mirror. Another viewer represented by 604 in proximity to a RR display system projector source will see a primary image, which may be an active image, e.g., video or other desired content. In this FIG. 604 illustratively shows a digital image of the viewer 603 trying on a different outfit using augmented reality. Similarly, yet another viewer represented by 605 is in close proximity to different projector source from the one used by viewer 604 will observe another primary image, which may have a completely different set of content, on the surface of 601 than what viewer 603 is seeing and what the other viewers like viewer 602 will observe. In FIG. 6, only 2 viewers are shown using display system as a RR display, however the system is not limited to 2 RR display locations. This unique system allows an aesthetically pleasing mirror to be used by multiple users as a mirror and simultaneously be used by multiple users as an RR display system.

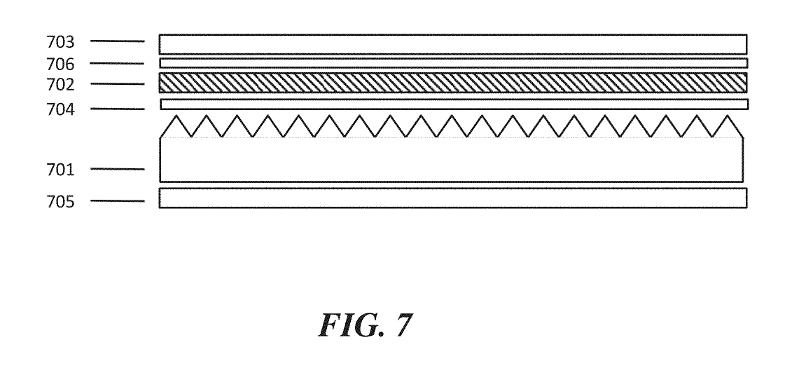

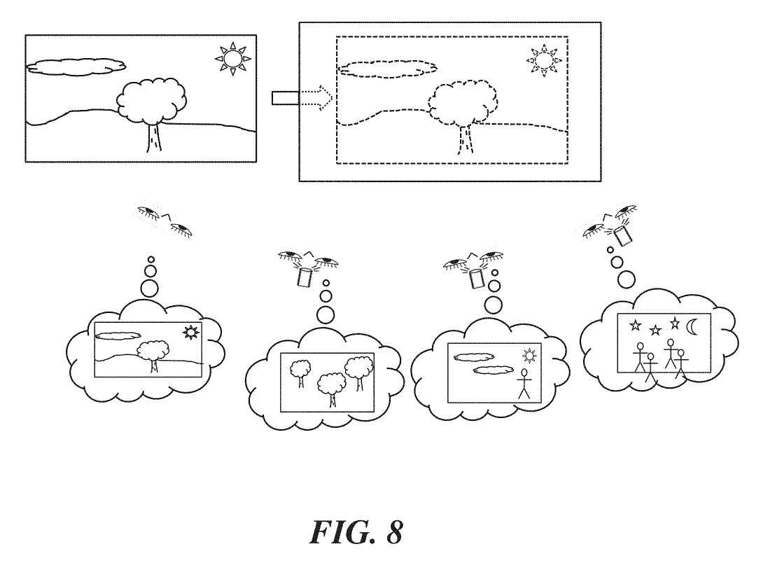

In the following, other hybrid systems will now be outlined. In the display screen and the system described below with respect to FIGS. 7 and 8, the secondary display medium is formed at a greater depth than the retro-reflective display medium relative to a display surface, and wherein the retro-reflective display medium is formed of a semi-transparent or partially transparent material and configured to partially transmit light such that the secondary display medium is viewable through the retro-reflective display medium.

FIG. 7 schematically shows an illustrative hybrid RR overlay display system comprising a semi-transparent or transparent RR layer combined with active or static portion of the display system behind the RR layer. Similar to embodiments described above with respect to FIGS. 4 and 5, a retro-reflective display medium includes a RR layer 701. A secondary display medium, which is formed at a greater depth than the retro-reflective display medium, includes a layer or object 702 that is showing active or static content. In some embodiments, the secondary display medium comprises a static content layer. In these embodiments, e.g., the layer 702 could be a poster, picture, painting or other such static content. In other embodiments, the secondary display medium comprises an active content source or layer having an internal light source. In these embodiments, e.g., the layer or object 702 could be an active LCD display, an active OLED display, an active LED display or other such active display surface. 703 represents an optional layer providing rigid support. This layer may help the overall system to be flat or it may be curved or it may be segmented at different angles to emulated a curved shape for the overall screen portion of the display system. A flexible configuration for all layers in the stack may be useful in allowing for a flexible system that can be rolled up for an increased range of configurations. 704 represents an optional backing layer for the RR layer 701. 705 represents an optional front layer that can be used to optimize front surface reflective properties or for mounting configurations. Examples include a multi-layered anti-reflection coating, a diffuse scattering layer to reduce glare, or a fully transparent lamination surface to assist in mounting and sealing/protection of the system. 706 represents an optional adhesive mounting layer.

FIG. 8 schematically illustrated the multiuser capability of the representative hybrid RR overlay display system outlined in FIG. 7. FIG. 7 illustrates how multiple users will be able to simultaneously view different content on the same display area at the same time. In this example, the viewer on the left, without the projector system, would see a secondary image through the semi-transparent or transparent RR material, and see the representative active or static content, for example from an active display or a static printed image. The viewers on the right, on the other hand, who are in proximity to projector systems, would see primary images, which can be individualized for different viewers. When the projectors are turned on, these viewers, while primarily or only seeing the unique images rendered by the retro-reflective display media and the projectors of their individual systems, would either not see or see a faint secondary image through the retro-reflective display medium, depending on the relative intensities between the primary and secondary images. Although only one viewer is shown on the left, an unlimited number of additional viewers without the projection system would see through the semi-transparent and transparent RR material, in a manner like the viewer on the left.

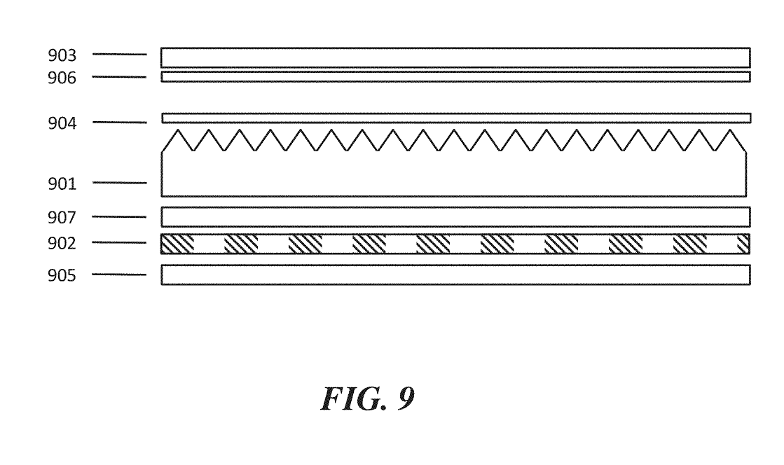

In the display screen described below with respect to FIG. 9, unlike the display screen described above with respect to FIG. 7, the retro-reflective layer is formed at a greater depth than the secondary display medium relative to a display surface, wherein the secondary display medium is configured to partially transmit light such that the primary image is visible through the secondary display medium. FIG. 9 schematically shows a hybrid RR static-overlay display with an illustrative method to optimize the system performance using a perforation approach on the static overlay portion of the system. This type of representative configuration allows optimization the relative brightness and image quality between the static overlay content and the RR portion of the display system. A retro-reflective display medium comprises a RR layer 901. A secondary display medium comprises a layer or object 902 represents that is showing static content such as a poster, picture, painting or other such static content. In this case 902 has been “perforated” in order to allow a desired percentage of light to pass through 902 in with no reflection or absorption. 903 represents an optional layer providing rigid support. This layer may help the overall system to be flat or it may be curved or it may be segmented at different angles to emulated a curved shape for the overall screen portion of the display system. A flexible configuration for all layers in the stack may be useful in allowing for a flexible system that can be rolled up for an increased range of configurations. 904 represents an optional backing layer for the RR layer 901. 905 represents an optional front layer that can be used to optimize front surface reflective properties or for mounting configurations. 906 represent an optional adhesive mounting layer. 907 represents an optional optical adhesive mounting layer. One of the primary benefits of this type of system is that the static content being in front of the RR layer is always visible which enables increased ability to tune to visual appearance of this content. The holes used for 902 can be off different pitch, size and relative areal coverage depending on the desired viewing properties of the static content and the RR display content. Similar to layer 506 described in FIG. 5, the hole size should not be too large nor too small relative to the RR optical element size depending on display system intended layout. As an illustrative example, if a 3 meter wide display is being viewed from a typical distance of 6 meters, the a hole size of >3 mm may be deemed too large, resulting in a negative impact to visual quality. Similarly if the RR element size is 0.25 mm in size, then a hole size of 0.1 mm may be too small, resulting in negative impacts to the RR displayed content. The advantage of the configuration shown in this figure versus the configuration shown in FIG. 7 is that each of the static content from 902 and active RR display content from 901 is viewed without optical interference from the other layer. In FIG. 7, the static poster content 702 is behind a contiguous RR layer and can suffer from a loss of content brightness and clarity from certain angles.

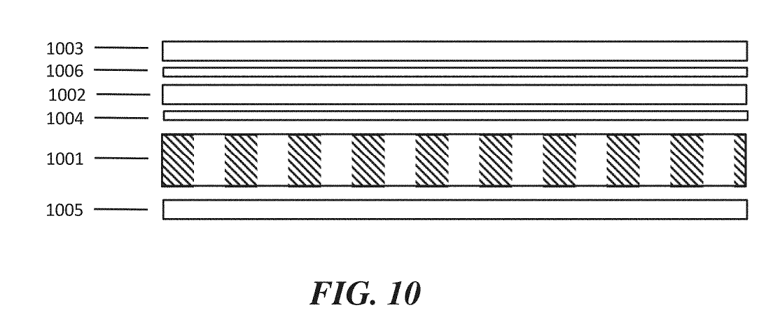

The visibility of secondary image can be improved by increasing visibility through the retro-reflective display medium. FIG. 10 schematically shows a hybrid RR overlay display with an illustrative method to optimize the system performance using a perforation approach on the RR portion of the system. In this system 1001 represents the perforated RR layer. In the display screen described with FIG. 10, similar to the display screen described above with respect to FIG. 7, the retro-reflective layer is formed at a shallower depth than the secondary display medium relative to a display surface. For better clarity, the layer is drawn without the illustrative representations of the optical elements. 1002 represents the layer displaying the static or active media. 1003 shows the optional rigid or flexible backing layer. 1004 represents an optional optically clear mounting layer. 1005 represents an optional front layer that can be used to optimize front surface reflective properties or for mounting configurations. 1006 represents an optional adhesive mounting layer. The perforation for layer 1001 allows for improved ability to optimize the visual appearance of layer 1002 for viewer not viewing the display system from a retro-reflective display location. Again, hole shape, size and pitch can all be adjusted to optimize overall system parameters depending on the specific application. With this example sequence of layers, a portion of incident light can reach and reflect off layer 1002 without impact from transmission and refraction though any RR material.

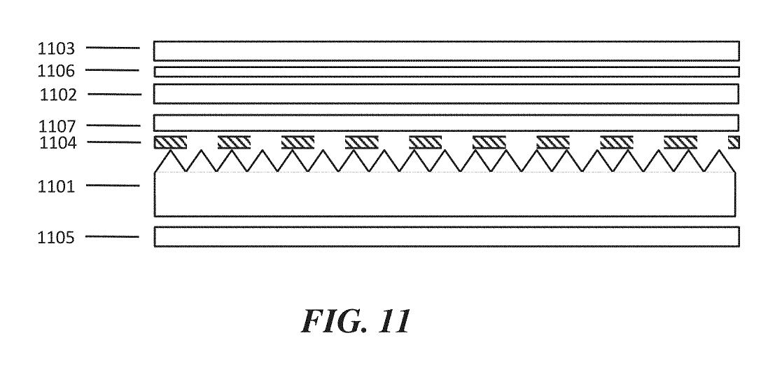

FIG. 11 schematically shows a display screen which comprises a semitransparent or partially transparent layer formed between the retro-reflective display medium and the secondary display medium, where the semitransparent or partially transparent layer having a plurality of holes formed therethrough to improve visibility of the secondary image. As illustrated, the illustrative hybrid RR overlay display with a method to optimize the system performance using a perforation approach on a layer of the system between the RR layer and the static or active content behind the RR layer. The purpose of this configuration is to allow portions of the RR layer 1101 to become transparent and non-retro-reflective in its optical properties. 1102 shows the layer displaying the static or active media. 1103 shows the optional rigid or flexible backing layer. 1104 is a perforated layer that is positioned between the RR layer 1101 and a layer 1107. Layer 1107 may be an adhesive or some other material that is optically clear, but that also has conformal properties such a portion of the material will pass through the perforations of layer 1104 and conform to the backside of the optical elements of 1101 resulting in the elimination or significant reduction of the index of refraction change from 1101 to the air that would result otherwise. This reduction or elimination of the index of refraction change will significantly reduce the amount of total internal reflection at the backside of the optical elements for the RR film 1101. Similar to the other configurations reviewed, there is an optional layer 1105 that serves for potential antireflection, diffusive and/or lamination purposes. 1102 is an optional mounting layer. As in other cases reviewed, hole shape, size and pitch for the perforated layer 1104 can all be adjusted to optimize overall system parameters depending on the specific application.

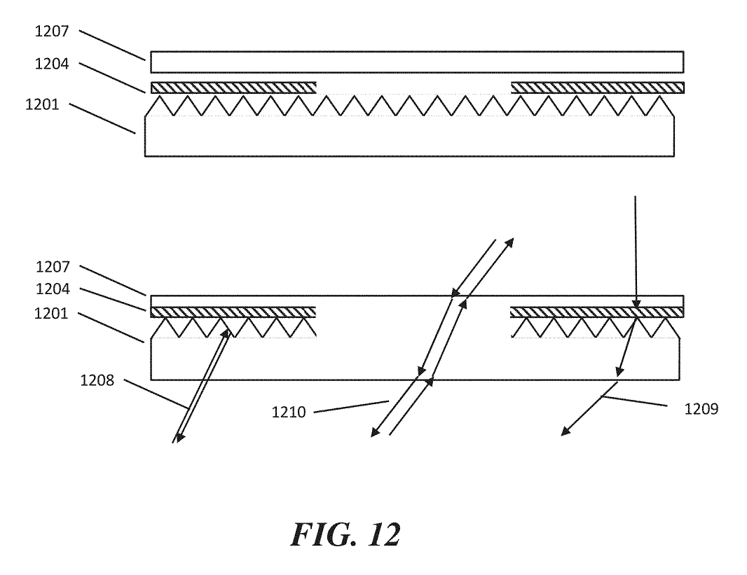

FIG. 12 schematically shows the impact of the perforation layer in combination with a layer that substitutes for air on the backside of the RR layer with a magnified cross-sectional view of one of the perforated regions. Layers 1201, 1204 and 1207 correspond to the same layers 1101, 1104, 1107 respectively. The top portion of the figure shows the layers prior to physical contact and assembly of the overall system. The bottom portion of the figure shows the layers after the system has been assembled. We can see that after system assembly, 1207 has penetrated through the hole in 1204 and filled in the optical elements on the backside of 1201 in the region of the hole. 1208 shows an incident and retro-reflected beam of light on a region of the screen away from the hole exhibiting the expected RR behavior. 1209 shows the path of light coming through from the backside of the stack from either static or active content behind layer 1207. For 1209 we can see illustratively that the direction of the light originating from the backside can be significantly deflected due to the combination of surface angles and refractive index differences through the stack of layers. For the case of 1210 which shows and incident and reflected beam of light through the hole in layer 1204, we observe that with the elimination or significant reduction of the refractive indicate step from the backside of 1201 to air, we no longer have retro-reflection in this region. Additionally, the direction of the light coming through the backside will largely remain unchanged which results in less negative visual impact to the static/active content behind the RR layer 1201.

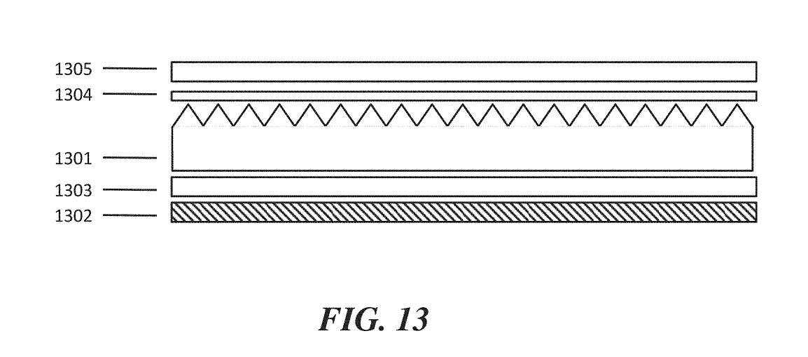

The display screens described herein can include, in addition to a retro-reflective display medium and a secondary display medium, a tertiary display medium configured to display a tertiary image, wherein the retro-reflective display medium, the secondary display medium and the tertiary medium are stacked in the display depth direction and are laterally overlapping in the lateral direction. FIG. 13 schematically shows illustrative sequence of layers for a hybrid RR-mirror-active display system. In this Figure, a basic hybrid system is shown however, more complex systems incorporating elements outline above such as perforated layers may also be incorporated. 1301 represents the RR layer for the system. 1302 represents a partially or semi-reflective layer that reflects a portion of incident light and allows transmission of a portion of the incident light. 1303 represents an optional transparent layer that may be used for improved flatness or system level structural rigidity. Additional transparent optical adhesive layers may also be incorporated between various layers for mounting purposes. 1304 represents an optional backing layer. 1305 represents a layer that provides active content. This system would provide multiple viewing capabilities. For viewers in proximity to a projector paired with the RR screen, they would see the active RR display content. Multiple viewers could see this content. With the active content 1305 inactive, other viewers not in proximity to one of the RR display system projectors would see what appears to be a traditional mirror. With the active content 1305 activated, other viewers not in proximity to one of the RR display system projectors would see what appears to be a traditional LED/LCD display system.

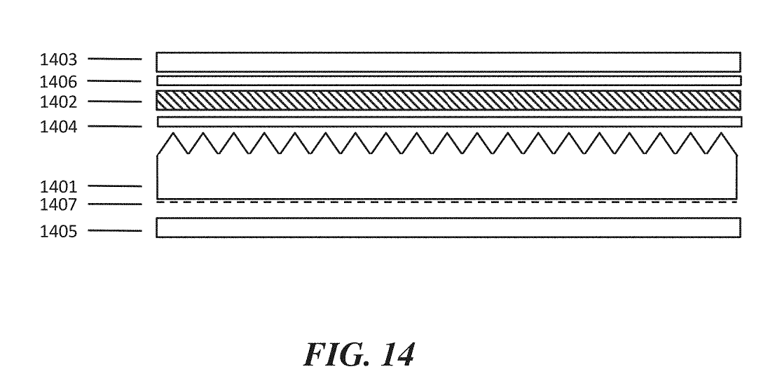

FIG. 14 schematically shows an illustrative hybrid RR direct print display system with an illustrative method to combine content semi-transparent or digitally “perforated” content either directly on the RR layer or on a transparent layer in front of the RR layer. Layers 1401/1403/1404/1405/1406 have functions analogous to those outlined for 901/903/904/905/906 respectively in FIG. 9 and the associated description for FIG. 9. Object 1402 represents the digital print, however in this configuration, the print is directly on the front side of the RR layer 1401. There are a number of ways in which to implement this RR direct print. In one such best practice the print layer may be semi-transparent in order to not completely block light from reaching the RR elements. In another best practice, the print may be digitally perforated. Digitally perforation in this context refers to digitally modifying a portion of the image to be clear or not printed such that the printed image emulates a traditional perforated digital print. The advantage of using the digital perforation method proposed herein is that the shape, size, pitch and coverage area of the can all be very quickly and easily changed depending on the desired balance between the static printed image and the RR display content. These parameters may also be modified non-uniformly within a single print such that certain areas of the screen have a stronger RR image versus the print image or vice versa. In another best practice the digitally perforated print layer may be opaque in printed regions such light does not reach the RR elements in areas with the print content. This may be desirable to reduce interference between the print content and the RR display content.

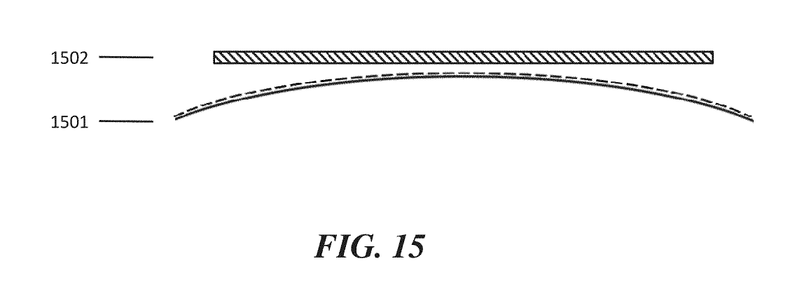

FIG. 15 schematically shows a hybrid RR-active combined display system that implements a curved or non-flat layer for optimization of the RR display properties. In this figure, 1501 represents the RR layer with a dashed line to illustratively represent the optical elements. 1502 represents the active display. For clarity, some of the optional system elements are not shown in this Figure. With a flat RR layer in front of an active LED or LCD display rather than the curved configuration shown in this Figure, the light and image from the active display can bleed through the back side of the RR layer especially at the edges and corners of the field of view. As has been disclosed, e.g., in U.S. Provisional Patent Application No. 62/370,690, very little light passes through from the backside of a RR layer in a direction normal to the surface of the RR layer. By curving layer 1501 as shown in FIG. 15, most of the RR display surface will have surface normal vectors that are directed towards the viewer. As a result, there will be a significant reduction in bleed through of the active display content especially for a viewer centered on the display area. For viewers/projectors not in the center location, there will be a reduction in the range of angles for the surface normal so viewing quality will also be improved. For best practices, the radius of curvature should be roughly in a range similar to the viewer to screen distance. Note that FIG. 15 is illustrative and drawn with a top-down perspective for a landscaped oriented configuration. If a display system is using a portrait configuration, then it would be more beneficial to have the curvature in the vertical direction. For some applications, such as very large displays with viewers relatively near the display, it may be beneficial to have curvatures in multiple directions, emulating a concave spherical surface. Segmented and angled configurations may also be used to approximate a curved surface.

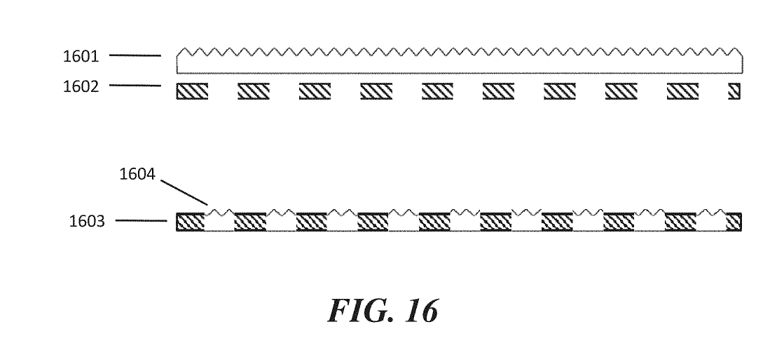

FIG. 16 schematically shows a hybrid RR-active combined display system that combines RR and active display elements. This method to integrate a traditional active LED, OLED or LCD display with the RR display is to make use of portions of the active display area that are either transparent or not used for the traditional active display light output. Two possible configurations are shown in this Figure. 1601 shows an RR layer that is behind an active display area 1602. In this case, 1602 is illustratively drawn with gaps to represent areas within and around each active LCD or pixel that allow transmission of light. Some new generations of LCD and OLED displays have utilized this feature to manufacture transparent displays. With the sequence of layers 1601 and 1602, a hybrid display may be made which allows a transparent or semi-transparent active display to be seen by a multitude of viewers, while at the same time several other RR perspectives may each show completely different content to another set of users on the same display area. In the bottom portion of this Figure, 1603 and 1604 illustratively show another method by which to implement such a system. In this case, rather than having the RR layer behind the active area, it may be possible in some cases to more tightly integrate the RR portions of the display within the traditional active display. This method can work well in conjunction with LED based displays wherein the distances between pixels can range from less than 1 mm to >10 mm. In this scenario, the integration of the active/RR portions of the display may be after the LED manufacturing. For other configurations, it may be possible to integrate the RR portion of the display as part of the LCD/OLEM display manufacturing process.

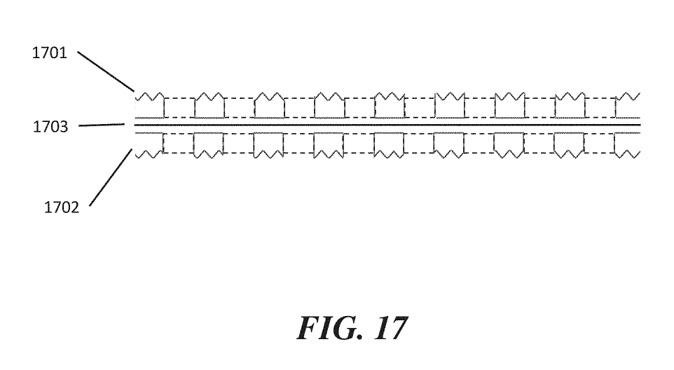

FIG. 17 schematically shows a RR display system that enables a double sided display media. This class of configuration could be applied to many of the configurations outlined above. In this Figure, 1701 shows a perforated RR layer, while 1702 shows a second perforated RR layer facing the opposite direction from 1701. Between 1701 and 1702 is an optional transparent layer 1703 configured to maintain alignment between 1701 and 1702. An example of 1703 implementation may be a transparent double sided adhesive layer. In this illustrative example, with the perforations aligned, the combined media stack would be transparent, while allowing RR display content to be viewed from either side of the screen.

### Computer Systems

Another aspect of the present disclosure provides a system that is programmed or otherwise configured to implement the methods of the disclosure. The system can include a computer server that is operatively coupled to a projector and a photo detector. The projector and photo detector can be standalone units, or integrated as a projection and detection system.

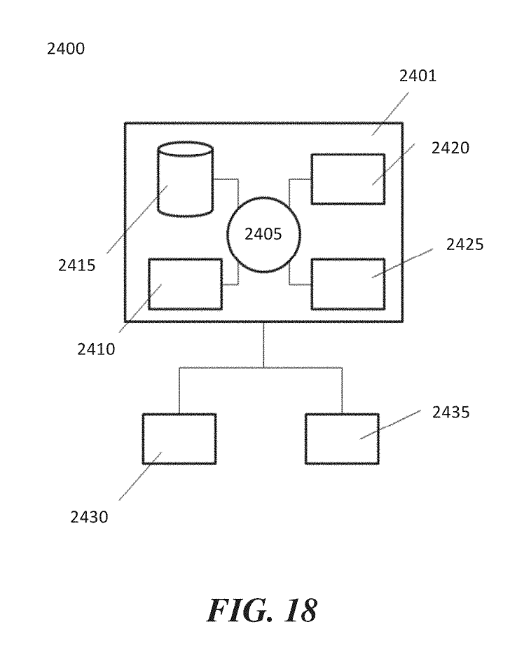

FIG. 18 shows a system 2400 comprising a computer server (“server”) 2401 that is programmed to implement methods disclosed herein. The server 2401 includes a central processing unit (CPU, also “processor” and “computer processor” herein) 2405, which can be a single core or multi core processor, or a plurality of processors for parallel processing. The server 2401 also includes memory 2410 (e.g., random-access memory, read-only memory, flash memory), electronic storage unit 2415 (e.g., hard disk), communication interface 2420 (e.g., network adapter) for communicating with one or more other systems, and peripheral devices 2425, such as cache, other memory, data storage and/or electronic display adapters. The memory 2410, storage unit 2415, interface 2420 and peripheral devices 2425 are in communication with the CPU 2405 through a communication bus (solid lines), such as a motherboard. The storage unit 2415 can be a data storage unit (or data repository) for storing data. The server 2401 can be operatively coupled to a computer network (“network”) with the aid of the communication interface 2420. The network can be the Internet, an internet and/or extranet, or an intranet and/or extranet that is in communication with the Internet. The network in some cases is a telecommunication and/or data network. The network can include one or more computer servers, which can enable distributed computing, such as cloud computing. The network, in some cases with the aid of the server 2401, can implement a peer-to-peer network, which may enable devices coupled to the server 2401 to behave as a client or a server.

The storage unit 2415 can store files or data. The server 2401 can include one or more additional data storage units that are external to the server 2401, such as located on a remote server that is in communication with the server 2401 through an intranet or the Internet.

In some situations, the system 2400 includes a single server 2401. In other situations, the system 2400 includes multiple servers in communication with one another through an intranet and/or the Internet.

The server 2401 can be adapted to store user information and data of or related to a projection environment, such as, for example, display angles and intensity settings. The server 2401 can be programmed to display an image or video through a projector coupled to the server 2401.

Methods as described herein can be implemented by way of machine (or computer processor) executable code (or software) stored on an electronic storage location of the server 2401, such as, for example, on the memory 2410 or electronic storage unit 2415. During use, the code can be executed by the processor 2405. In some cases, the code can be retrieved from the storage unit 2415 and stored on the memory 2410 for ready access by the processor 2405. In some situations, the electronic storage unit 2415 can be precluded, and machine-executable instructions are stored on memory 2410.

The code can be pre-compiled and configured for use with a machine have a processer adapted to execute the code, or can be compiled during runtime. The code can be supplied in a programming language that can be selected to enable the code to execute in a pre-compiled or as-compiled fashion.

The server 2401 is coupled to (e.g., in communication with) a projector 2430 and a photo detector 2435. In an example, the projector 2430 can project an image or video onto a retro-reflective screen. In another example, the projector 2430 can project ultraviolet or infrared light onto the retro-reflective screen. The photo detector 2435 can detect (or measure) reflected light from the retro-reflective screen.

The projector 2430 can include one or more optics for directing and/or focusing an image or video onto the retro-reflective screen. The photo detector can be a device that is configured to generate an electrical current upon exposure to light, such as, for example, a charge-coupled device (CCD).

Aspects of the systems and methods provided herein, such as the server 2401, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables, copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

Methods and systems of the present disclosure can be implemented by way of one or more algorithms. An algorithm can be implemented by way of software upon execution by the central processing unit 2405.

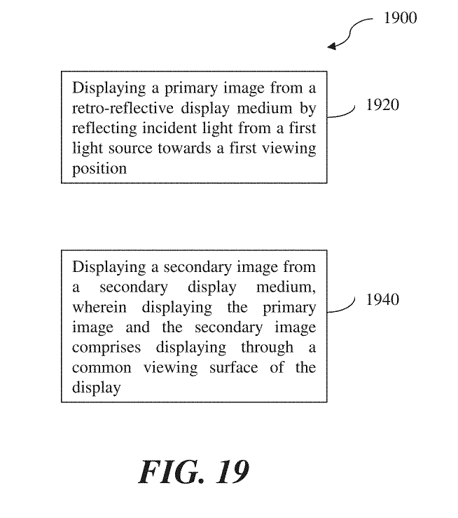

FIG. 19 schematically illustrates a method 1900 of displaying viewing position-dependent images, according to embodiments. The method 1900 comprises displaying 1920 a primary image from a retro-reflective display medium by reflecting incident light from a first light source towards a first viewing position. The method additionally comprises displaying 1940 a secondary image from a secondary display medium. The retro-reflective display medium and the secondary medium are stacked in a display depth direction and are laterally overlapping in a lateral direction perpendicular to the depth direction, such that displaying the primary image and the secondary image comprises displaying through a common viewing surface of the display.

### EXAMPLE EMBODIMENTS

1. A display screen configured to display viewing position-dependent images, the display screen comprising:
a retro-reflective display medium configured to display a primary image by reflecting incident light from a first light source towards a first viewing position; and
a secondary display medium configured to display a secondary image,
wherein the retro-reflective display medium and the secondary display medium are stacked in a display depth direction and overlap in a lateral direction perpendicular to the display depth direction.

2. The display screen of Embodiment 1, wherein the retro-reflective display medium is configured such that the primary image is visible from the first viewing position within a first range of return angles, and wherein the secondary display medium is configured such that the secondary image is visible from a second viewing position within a second range of return angles that is substantially greater than the first range of return angles and includes the first range of return angles.

3. The display screen of Embodiment 2, wherein the first range of return angles is centered about a direction of reflection of the incident light towards the first viewing position and is less than about 20 degrees.

4. The display screen of Embodiment 2, wherein a luminance of the primary image falls off by more than about 50% outside the first range of return angles.

5. The display screen of Embodiment 2, wherein a luminance of the secondary image is less than about 10% relative to a luminance of the primary image within the first range of return angles when the primary image is present.

6. The display screen of Embodiment 2, wherein a luminance of the secondary image is less than about 25% of a luminance of the primary image within the first range of return angles when the primary image is present.

7. The display screen of any one of Embodiments 1-6, wherein one or both of the retro-reflective display medium and the secondary display medium comprise a semi-transparent layer formed of a material configured to transmit between about 10% and about 90% of the incident light.

8. The display screen of any one of Embodiments 1-6, wherein one or both of the retro-reflective display medium and the secondary display medium comprise a partially transparent layer having local regions that are modified to have increased transparency relative to remaining regions.

9. The display screen of any one of Embodiments 1-8, wherein the retro-reflective display medium is formed at a greater depth than the secondary display medium relative to a display surface of the display screen, and wherein the secondary display medium is configured to partially transmit light directed to the retro-reflective display medium.

10. The display screen of Embodiment 9, wherein the secondary display medium is configured to serve as a mirror which partially reflects external light such that the secondary image comprises a mirror image.

11. The display screen of any one of Embodiments 9-10, wherein the secondary display medium comprises a plurality of holes formed therethrough.

12. The display screen of any one of Embodiments 1-8, wherein the secondary display medium is formed at a greater depth than the retro-reflective display medium relative to a surface of the display screen, and wherein the retro-reflective display medium is formed of a semi-transparent or partially transparent layer and configured to partially transmit light such that the secondary display medium is viewable through the retro-reflective display medium.

13. The display screen of Embodiment 12, wherein the secondary display medium comprises a static content layer.

14. The display screen of Embodiment 12, wherein the secondary display medium comprises an active content layer or object having an internal light source.

15. The display screen of Embodiment 14, wherein the secondary display medium comprises a liquid crystal display (LCD), a light emitting diode (LED) display or an organic light emitting diode (OLED) display.

16. The display screen of any one of Embodiments 12-14, wherein the retro-reflective display medium comprises a plurality of holes formed therethrough.

17. The display screen of any one of Embodiments 8-10, further comprising a semitransparent or partially transparent layer formed between the retro-reflective display medium and the secondary display medium, the semitransparent or partially transparent layer having a plurality of holes formed therethrough.

18. The display screen of any one of Embodiments 1-8, wherein the retro-reflective display medium is formed at a greater depth than the secondary display medium relative to a display surface of the display screen, and wherein the secondary display medium is configured to partially transmit light such that the primary image is visible through the secondary display medium.

19. The display screen of Embodiment 14, wherein the secondary display medium comprises a semitransparent or partially transparent layer having a plurality of holes formed therethrough.

20. The display screen of any one of Embodiments 1-8 and 12-19, further comprising a tertiary display medium configured to display a tertiary image, wherein the retro-reflective display medium, the secondary display medium and the tertiary display medium are stacked in the display depth direction and overlap in the lateral direction.

21. The display screen of Embodiment 20, wherein the tertiary display medium comprises a second semi-transparent or partially transparent layer configured to serve as a partial mirror such that the tertiary image comprises a mirror image.

22. The display screen of Embodiment 21, wherein the tertiary display medium is formed closer to the display surface of the display screen relative to the retro-reflective display medium and the secondary display medium.

23. The display screen of any one of Embodiments 1-22, wherein the retro-reflective display medium comprises a repeating pattern of corner cube reflectors.

24. The display screen of any one of Embodiments 1-22, wherein the retro-reflective display medium comprises a repeating pattern of bead-based retro-reflectors.

25. The display screen of any one of Embodiments 1-22, wherein the retro-reflective display medium comprises a repeating pattern of undistorted corner cube reflectors, wherein each of the undistorted corner cube reflectors has three adjoining surfaces, wherein each of the adjoining surfaces is substantially perpendicular to the other two of the adjoining surfaces.

26. The display screen of any one of Embodiments 1-22, wherein the retro-reflective display medium comprises a repeating pattern of distorted corner cube reflectors, wherein each undistorted corner cube reflector has three adjoining surfaces, wherein each adjoining surface substantially deviates from perpendicular to the other two adjoining surfaces.

27. The display screen of any one of Embodiments 1-22, wherein the retro-reflective display medium has a concave curvature relative to the first and second viewing positions.

28. The display screen of any one of Embodiments 1-22, wherein the secondary display medium comprises a directly printed pattern on the retro-reflective display medium.

29. The display screen of any one of Embodiments 1-22, wherein the secondary display medium comprises a directly printed pattern on a transparent substrate.

30. The display screen of any one of Embodiments 28-29, wherein the directly printed pattern comprises a semitransparent or partially transparent layer having a plurality of holes formed therethrough.

31. The display screen of any one of Embodiments 1-30, further comprising a diffusive scattering layer stacked in the display depth direction and overlapping in the lateral direction perpendicular to the display depth direction.

32. The display screen of Embodiment 31, wherein the diffusive scattering layer is configured to be interposed between the first light source and the retro-reflective display medium and between the first light source and the secondary display medium.

33. The display screen of Embodiment 31, wherein the diffusive scattering layer is formed between the retro-reflective display medium and the secondary display medium.

34. A display system, comprising:
the display screen according to any one of Embodiments 1-33;
the first light source comprising a projector configured to direct the incident light towards the retro-reflective display medium to display the primary image; and
a micro-processor in communication with the projector, wherein the micro-processor is programmed to control the first light source to direct the incident light towards the retro-reflective display medium.

35. The display system of Embodiment 34, further comprising a sound system for providing sound to complement the primary image, wherein the primary image comprises a still image or a video.

36. The display system of Embodiment 34 or 35, wherein the primary image comprises a three-dimensional image.

37. The display system of Embodiment 34, wherein the micro-processor is further programmed to:
determine a position and/or orientation of a viewer; and
dynamically adjust the still image or the video on the retro-reflective display medium based on a determined position and orientation.

38. A method of displaying viewing position-dependent images, the method comprising:
displaying a primary image from a retro-reflective display medium by reflecting incident light from a first light source towards a first viewing position; and
displaying a secondary image from a secondary display medium,
wherein the retro-reflective display medium and the secondary medium are stacked in a display depth direction and overlap in a lateral direction perpendicular to the display depth direction, such that displaying the primary image and the secondary image comprises displaying through a common viewing surface of the display.

39. The method of Embodiment 38, wherein displaying the primary image comprises displaying the primary image that is visible from the first viewing position within a first range of observation angles.

40. The method of Embodiment 39, wherein displaying the secondary image comprises displaying the secondary image that is visible at least outside the first range of observation angles.

41. The method of Embodiment 40, wherein displaying the secondary image comprises displaying the secondary image within a second range of observation angles that is substantially greater than the first range of observation angles and includes the first range of observation angles.

42. The method of Embodiment 41, wherein displaying the secondary image comprises superimposing the secondary image on first primary image inside the first range of observation angles, the superimposed secondary image having a luminance that is lower relative a luminance of the primary image.

43. The method of Embodiment 42, wherein the luminance of the secondary image is at least about 20% of the luminance of the primary image within the first range of observation angles.

44. The method of Embodiment 43, wherein the luminance of the secondary image outside the first range of observation angles is greater than twice the luminance of the primary image.

45. The method of any one of Embodiments 38-44, wherein displaying the secondary image comprises partially reflecting external light such that the secondary image comprises a mirror image.

46. The method of any one of Embodiments 38-44, wherein the secondary display medium is disposed at a greater depth in the display depth direction than the retro-reflective display medium relative to a display surface, and wherein the retro-reflective display medium that is formed of a semi-transparent or partially transparent material configured to partially transmit light, such that the secondary image is displayed through the retro-reflective display medium.

47. The method of Embodiment 46, wherein displaying the secondary image comprises displaying a static content from the secondary display medium by partially reflecting external light.

48. The method of Embodiment 46, wherein the secondary display medium has an internal light source, and wherein displaying the secondary image comprises displaying an active content from the secondary display medium.

49. The method of any one of Embodiments 38-48, further comprising displaying a tertiary image from a tertiary display medium, wherein the retro-reflective display medium, the secondary medium and the tertiary medium are stacked in the display depth direction and overlap in the lateral direction, such that displaying the primary image, displaying the secondary image and displaying the tertiary image comprises displaying through the common viewing surface of the display.

50. A display screen configured to display viewing position-dependent images, the display screen comprising:
a retro-reflective display medium configured to display a primary image by reflecting incident light from a first light source towards a first viewing position; and
a diffusive scattering layer configured to diffusively scatter light passing therethrough,
wherein the retro-reflective display medium and the diffusive scattering layer are stacked in a display depth direction and overlap in a lateral direction perpendicular to the display depth direction.

51. The display screen of Embodiment 50, further comprising a secondary display medium configured to display a secondary image,

52. The display screen of Embodiment 51, wherein the diffusive scattering layer is configured to be interposed between the first light source and the retro-reflective display medium and between the first light source and the secondary display medium.

53. The display screen of Embodiment 51, wherein the diffusive scattering layer is formed between the retro-reflective display medium and the secondary display medium.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or connected”, as generally used herein, refer to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a measurement error.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states.

The teachings of the inventions provided herein can be applied to other systems, not necessarily the systems described above. The elements and acts of the various embodiments described above can be combined to provide further embodiments. The acts of the methods discussed herein can be performed in any order as appropriate. Moreover, the acts of the methods discussed herein can be performed serially or in parallel, as appropriate.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure. Accordingly, the scope of the present inventions is defined by reference to the claims.

What is claimed is:

1. A display screen configured to display viewing position-dependent images, the display screen comprising:
a retro-reflective display medium configured to display a primary image by reflecting incident light from a light source towards a first viewing position; and
a secondary display medium configured to display a secondary image,
wherein the retro-reflective display medium and the secondary display medium are stacked in a display depth direction and overlap in a lateral direction perpendicular to the display depth direction.

2. The display screen of claim 1, wherein the retro-reflective display medium is configured such that the primary image is visible from the first viewing position within a first range of return angles, and wherein the secondary display medium is configured such that the secondary image is visible from a second viewing position within a second range of return angles that is substantially greater than the first range of return angles and includes the first range of return angles.

3. The display screen of claim 2, wherein the first range of return angles is centered about a direction of reflection of the incident light towards the first viewing position and is less than about 20 degrees.

4. The display screen of claim 2, wherein a luminance of the primary image falls off by more than about 50% outside the first range of return angles.

5. The display screen of claim 2, wherein a luminance of the secondary image is less than about 10% relative to a luminance of the primary image within the first range of return angles when the primary image is present.

6. The display screen of claim 1, wherein one or both of the retro-reflective display medium and the secondary display medium comprise a partially transparent layer having local regions that are modified to have increased transparency relative to remaining regions.

7. The display screen of claim 1, wherein the retro-reflective display medium is formed at a greater depth than the secondary display medium relative to a viewing surface of the display screen, and wherein the secondary display medium is configured to partially transmit light directed to the retro-reflective display medium.

8. The display screen of claim 7, wherein the secondary display medium is configured to serve as a mirror which partially reflects external light such that the secondary image comprises a mirror image.

9. The display screen of claim 7, wherein the secondary display medium comprises a plurality of holes formed therethrough.

10. The display screen of claim 1, wherein the secondary display medium comprises a directly printed pattern on the retro-reflective display medium.

11. The display screen of claim 1, further comprising a diffusive scattering layer stacked in the display depth direction and overlapping one or both of the retro-reflective display medium and the secondary display medium in the lateral direction perpendicular to the display depth direction.

12. The display screen of claim 11, wherein the diffusive scattering layer is interposed between the light source and the retro-reflective display medium and between the light source and the secondary display medium.

13. The display screen of claim 11, wherein the diffusive scattering layer is formed between the retro-reflective display medium and the secondary display medium.

14. A method of displaying viewing position-dependent images, the method comprising:
displaying a primary image from a retro-reflective display medium by reflecting incident light from a light source towards a first viewing position; and
displaying a secondary image from a secondary display medium,
wherein the retro-reflective display medium and the secondary medium are stacked in a display depth direction and overlap in a lateral direction perpendicular to the display depth direction, such that displaying the primary image and the secondary image comprises displaying through a common viewing surface of the display.

15. The method of claim 14, wherein displaying the primary image comprises displaying the primary image that is visible from the first viewing position within a first range of observation angles.

16. The method of claim 15, wherein displaying the secondary image comprises displaying the secondary image that is visible at least outside the first range of observation angles.

17. The method of claim 16, wherein displaying the secondary image comprises displaying the secondary image within a second range of return angles that is substantially greater than the first range of return angles and includes the first range of observation angles.

18. The method of claim 14, wherein the secondary display medium is disposed at a greater depth in the display depth direction than the retro-reflective display medium relative to a display surface, and wherein the retro-reflective display medium that is formed of a semi-transparent or partially transparent material configured to partially transmit light, such that the secondary image is displayed through the retro-reflective display medium.

19. The method of claim 18, wherein displaying the secondary image comprises displaying a static content from the secondary display medium by partially reflecting external light.

20. A display screen configured to display viewing position-dependent images, the display screen comprising:
a retro-reflective display medium configured to display a primary image by reflecting incident light from a first light source towards a first viewing position; and
a diffusive scattering layer configured to diffusively scatter light passing therethrough,
wherein the retro-reflective display medium and the diffusive scattering layer are stacked in a display depth direction and overlap in a lateral direction perpendicular to the display depth direction.
